(19) United States
(12) Patent Application Publication
(10) Pub. No.: US 2004/0146138 A1
(43) Pub. Date: Jul. 29, 2004

(54) Large flat panel gallium arsenide arrays on silicon substrate for low dose X-ray digital imaging

(75) Inventor: Jinbao Jiao, Gurnee, IL (US)

Correspondence Address: CARDINAL LAW GROUP, LLC, SUITE 2000, 1603 ORRINGTON AVENUE, EVANSTON, IL, 60201, US

(73) Assignee: MOTOROLA, INC.

(21) Appl. No.: 10/349,814

(22) Filed: Jan. 23, 2003

(51) Int. Cl. G21K 1/12

(52) U.S. Cl. 378/19

(57) ABSTRACT

The invention provides a method and system for digital x-ray imaging. The system includes a silicon substrate, a compound semiconductor including an array of imaging elements on the silicon substrate, and a scintillator layer operably disposed on the compound semiconductor layer. X-rays emitted from an x-ray source pass through a target object and are absorbed in the scintillator layer. The scintillator layer emits light in response to the absorbed x-rays, and the emitted scintillator light is detected by the array of imaging elements to provide an x-ray image corresponding to the x-rays traversing the target object.

### FIELD OF THE INVENTION

This invention relates generally to x-ray imaging systems. In particular, the invention relates to a method and system for generating x-ray images from an array of imaging elements, the imaging elements comprising a compound semiconductor on a silicon substrate.

### BACKGROUND OF THE INVENTION

In recent years, digitized x-ray image data have been used for medical x-ray diagnosing systems, for the identification of unseen objects such as objectionable items in luggage at an airport, and for quality-control testing of manufactured items. The advantages of electronic image sensors over older film imaging technology include more accurate measurements of x-ray intensity over greater ranges, an ability to directly digitize the image data, an ease of archiving and transmitting image data, and improved display capabilities. Newer digital x-ray sensing devices can provide real-time imaging, allowing for quicker medical diagnoses, faster security assessments and more efficient quality control in manufacturing.

Technologies for current X-ray digital imaging systems generally use one of two approaches. One method for X-ray imaging uses an X-ray scintillator such as cesium iodide with a hydrogenated amorphous silicon detector array. A scintillator device uses indirect conversion where x-rays are converted into visible light by the scintillator. An example of the scintillator type is described by Gross et al. in “Radiation Detection Device,” U.S. Pat. No. 6,310,352, issued Oct. 30, 2001. A scintillator is a compound that absorbs x-rays and converts the energy to visible light. A scintillator may yield many light photons for each incoming x-ray photon; 20 to 50 visible photons out per 1 kV of incoming x-ray energy are typical. Scintillators usually consist of a high-atomic number material, which has high x-ray absorption, and a low-concentration activator that provides direct-band transitions to facilitate visible photon emission. Scintillators may be granular like phosphors or crystalline like cesium iodide. A similar approach uses an x-ray scintillator such as cesium iodide with a hydrogenated amorphous silicon detector array. Many x-ray imaging systems are based on the hydrogenated amorphous silicon. The scintillator generates visible light while the photodetector converts the photons from the scintillator to electric charge. A transistor active matrix circuit then may scan the charges in each pixel cell and output a digital signal. Unfortunately, this approach is limited because the sensitivity of amorphous silicon is low and the noise level is high.

Another technical approach to x-ray digital imaging uses x-ray photoconductive materials such as selenium or cadmium sulfide to convert the x-ray photons directly to electric charges. A tiled detector array using photoconductive materials is described by Tran in “Solid State Radiation Detector for X-Ray Imaging”, U.S. Pat. No. 6,262,421 issued Jul. 17, 2001; by Hoheisel et al. in “X-Ray Mammography Apparatus Having a Solid-State Radiation Detector,” U.S. Pat. No. 6,208,708 issued Mar. 27, 2001; by Kinno et al. in “Image Detecting Device and an X-Ray Imaging System”, U.S. Pat. No. 6,185,274 issued Feb. 6, 2001; and by Spivey et al. in “Imaging Device,” U.S. Pat. No. 5,886,353 issued Mar. 23, 1999. X-ray technology using photoconductive materials needs an applied bias to force electrons to migrate to the sensor plane. Photoconductive materials with higher x-ray absorption than silicon can be coated on an array of conductive charge collection plates, each supplied with a storage capacitor. These are able to produce hole-electron pairs when x-rays are absorbed, but the charge generated must be stored out of the layer to avoid lateral crosstalk. The applied field not only separates the charge, but also can direct it towards the collector plate directly below to maintain image sharpness.

Currently used in production, selenium has relatively low X-ray absorption and requires about 50 electron volts to produce a hole-electron pair, which result in limiting the minimum possible dose and the size of the signal that can be generated. The imaging performance of these techniques may be degraded by relatively low x-ray to visible light-conversion efficiencies, low-collection efficiencies of the light photons, additional quantum noise from the light photons, and loss of resolution due to light spreading in the x-ray to visible light converter. Due to low mobility, photoconductive materials may not be fast enough for high-speed sensing.

Some digital x-ray imaging systems use a fluorescing plate that converts each x-ray photon into a large number of visible light photons to produce a visible light image. The visible light image is then imaged onto an optical image sensor such as a charged couple device (CCD).

Technological efforts and advances for x-ray devices continue to focus on providing larger and clearer digital images for better diagnosis and detection of various objects, as well a providing the best images possible with lower doses of x-ray exposure. Therefore, a need still exists for improved x-ray devices that provide quality digital imaging with lower doses of x-ray exposure, greater x-ray and optical sensitivity, signals processing at a faster frame rate, and the ability to create larger pictures of even moving objects.

It is an object of this invention, therefore, to provide a method, system and device for generating x-ray images of target objects that requires lower doses of x-rays with high resolution, high sensitivity, a fast frame rate, and an enlarged panel size and that overcomes other aforementioned obstacles or difficulties.

### SUMMARY OF THE INVENTION

One aspect of the invention provides a system for digital x-ray imaging, comprising a silicon substrate, a compound semiconductor layer operably disposed on the silicon substrate, an array of imaging elements in the compound semiconductor layer, and a scintillator layer operably disposed on the compound semiconductor layer. X-rays emitted from an x-ray source traversing a target object are absorbed in the scintillator layer. The scintillator layer emits light in response to the absorbed x-rays. The emitted light is detected by the array of imaging elements to provide an x-ray image corresponding to the x-rays traversing the target object. A buffer layer may be positioned between the compound semiconductor layer and the silicon substrate.

Each imaging element may include a photodiode. Each imaging element may include a photodiode and a field-effect transistor to gate the photodiode. A metal layer may cover the field-effect transistor to block emitted light from the scintillator layer from striking the field-effect transistor.

The digital x-ray imaging system may include an addressable readout circuit coupled to the array of imaging elements to provide an electrical output from a set of imaging elements in the imaging element array. Conversion circuitry may be included in the silicon substrate to provide a digital output corresponding to the x-ray image.

Another aspect of the invention is a method of generating an x-ray image. X-rays are absorbed in a scintillator layer, the x-rays having passed through a target object. The scintillator layer emits light based on the absorbed x-rays. The emitted light is detected with an array of imaging pixels, the array of imaging pixels including a silicon substrate, a compound semiconductor layer operably disposed on the silicon, substrate, and a scintillator layer operably disposed on the semiconductor layer. An x-ray image is generated based on the light detected by the array of imaging pixels. A set of imaging pixels may be addressed with an addressable readout circuit to detect the emitted light.

Another aspect of the invention is a digital x-ray imaging system including an x-ray source; an x-ray detector array including a silicon substrate, a compound semiconductor layer operably disposed on the silicon substrate, and a scintillator layer operably disposed on the compound semiconductor layer; and a conversion circuit coupled to the x-ray detector array, the conversion circuit generating an x-ray image from the x-rays striking the detector array. A buffer layer may be positioned between the silicon substrate and the compound semiconductor layer.

The present invention is illustrated by the accompanying drawings of various embodiments and the detailed description given below. The drawings should not be taken to limit the invention to the specific embodiments, but are for explanation and understanding. The detailed description and drawings are merely illustrative of the invention rather than limiting, the scope of the invention being defined by the appended claims and equivalents thereof. The foregoing aspects and other attendant advantages of the present invention will become more readily appreciated by the detailed description taken in conjunction with the accompanying drawings.

### BRIEF DESCRIPTION OF THE DRAWINGS

Various embodiments of the present invention are illustrated by the accompanying figures, wherein:

FIG. 1 illustrates a digital x-ray imaging system, in accordance with one embodiment of the current invention;

FIG. 2 illustrates a digital x-ray imaging system, in accordance with another embodiment of the current invention;

FIG. 3 illustrates a cross-sectional view of a portion of a digital x-ray imaging system, in accordance with one embodiment of the current invention;

FIG. 4 illustrates a schematic illustration of a portion of a digital x-ray imaging system with an array of imaging pixels, in accordance with one embodiment of the current invention; and

FIG. 5 illustrates a flow diagram of a method for generating an x-ray image, in accordance with one embodiment of the current invention.

### DETAILED DESCRIPTION OF THE PRESENTLY PREFERRED EMBODIMENTS

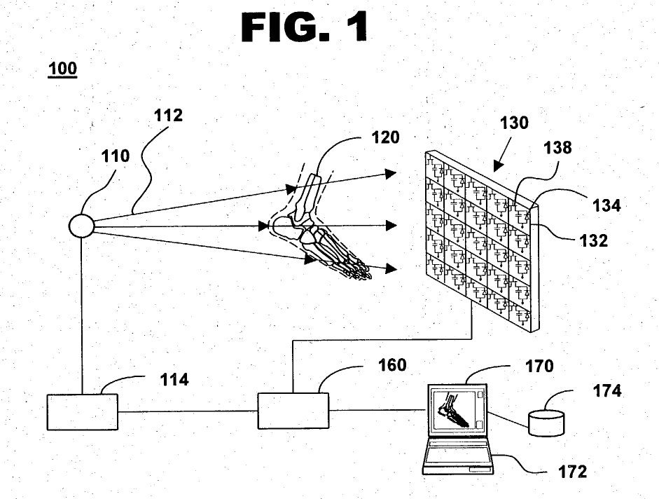

FIG. 1 shows a system for digital x-ray imaging, in accordance with one embodiment of the present invention at 100. Digital x-ray imaging system 100 includes an x-ray source 110, an x-ray detector array 130 to detect x-rays from the x-ray source, and a conversion circuit 160 coupled to x-ray detector array 130 for generating an x-ray image from x-rays 112 striking x-ray detector array 130.

X-ray source 110 generates x-rays 112. X-ray source 110 is typically powered by a high-voltage power supply 114. High-voltage power supply 114 may be turned on and off by conversion circuit 160. X-rays 112 are emitted when electrons are accelerated with a high voltage and directed into an x-ray emitting material such as tungsten. As the electrons decelerate, x-rays are emitted with an energy distribution near the accelerating potential of the high-voltage accelerator. The emitted x-rays travel away from the x-ray emitting material towards a target object 120. The x-ray source 110 is typically shielded to reduce the intensity of x-ray radiation in other directions. In one example, the x-rays are excited with a peak energy of 25 KeV. In another example, the x-rays are emitted in a range from 10 KeV to 100 KeV and above. As x-rays are difficult to focus, a point source is generally used for x-ray imaging. A point source is still the dominant x-ray source, since it is difficult to manipulate an x-ray by any lens.

Target object 120 is any object that can be imaged with x-rays, such as a hand, a knee, a foot, a chest, a breast, a tooth or other body part. In another setting, target object 120 may be a piece of luggage, a briefcase or a purse. In yet another setting, target object 120 may be a machined part, a welded pipe, or a reactor wall. Target object 120 partially absorbs the incident x-rays, so that x-rays that traverse the target object vary in intensity corresponding to the absorption within the target object. Less absorption of x-rays within a section of the target object results in a higher intensity of x-rays passing through that section.

X-ray detector array 130 includes an array of imaging pixels 132. Each imaging pixel includes an imaging element 134 such as a photodiode, a positive-intrinsic-negative (p-i-n) photodiode, a phototransistor, or a photodetector. Each imaging element 134 may comprise a photodiode and a field-effect transistor (FET) 138 to gate the photodiode. A scintillator layer is disposed on the imaging element. The photodiode and FET 138 provide an electrical signal in proportion to the incident x-ray intensity upon the scintillator layer above the imaging element. Output from imaging elements 134 may be gated and coupled to conversion circuitry 160.

Conversion circuitry 160 provides a digital output corresponding to the x-ray image. Conversion circuitry 160 provides a digitized output from selected pixels within x-ray detector array 130. Conversion circuitry 160 may contain clocking circuitry, amplification circuitry, analog-to-digital converters, comparators, a processor, memory, buffers and drivers to convert electrical signals from x-ray detector array 130 into any suitable format for storing, sending, transmitting or viewing. Conversion circuitry 160 may contain an addressable readout circuit coupled to the array of imaging elements to provide an electrical output from a set of imaging elements in the imaging element array such as a row of imaging elements. Conversion circuitry 160 may be located externally to x-ray detector array 130, coupled electrically to x-ray detector array 130 with a cable, connector, or other suitable interface. Alternatively, conversion circuitry 160 may be located entirely or in part within x-ray detector array 130. Output from conversion circuitry 160 may be sent to a digital x-ray imaging computer 170 running an application for displaying, storing, recalling, or otherwise manipulating the x-ray images.

Digital x-ray imaging computer 170 may have a monitor to view the x-ray images. Digital x-ray imaging computer 170 may have an input device 172 such as a keyboard or a mouse to control the generation, display and storage of x-ray images. X-ray images may be stored in storage unit 174, such as a database, a hard drive, or an optical memory disk.

In one embodiment of the present invention, a large two-dimensional array of GaAs thin film transistors and GaAs photodiodes on a silicon substrate form the imaging elements. A large image can be taken simultaneously and converted to digital signals, without requiring tiling of smaller arrays or otherwise assembling multiple arrays of detectors. A large panel of x-ray detectors has potentially lower cost than an aggregate of smaller arrays.

Large wafers of gallium arsenide (GaAs) or indium phosphide (InP) on a silicon substrate are used for the x-ray radiation-sensing array. Each cell of the GaAs array consists of a photodiode and a thin-film transistor for acquiring an image on a pixel-by-pixel basis. A thin layer of x-ray scintillator material is deposited on top of the GaAs arrays. X-ray photons striking each image cell are converted to visible light in the scintillator layer. A GaAs photodiode absorbs the light and converts the light to electric charges. A GaAs field-effect transistor circuit then scans the electric charges integrated in each photodiode and processes the signals as digital outputs.

The system can take an x-ray image with significantly improved speed and sensitivity. Low-dose x-ray exposures and high-quality digital images can be obtained using the detector array. Because of the high electron mobility of the GaAs devices, high-speed, real-time imaging can be achieved. The sensitivity of GaAs photodiode is orders of magnitude higher than hydrogenated amorphous silicon detectors; therefore, good x-ray images can still be obtained with a lower x-ray doses. Fast turn-on of GaAs photodiodes and rapid response to visible light implies that a very short time of x-ray radiation is needed.

High resolution with GaAs arrays can also be obtained, because of the high packing density of the pixel elements, large substrate size and high speed. For instance, a 700×700 pixel image (0.5 Mbyte size) can be processed in less than 1/100 second with a high-speed processor. This framing rate allows moving x-ray imaging.

Since GaAs photodiodes have orders of magnitude higher visible light absorption efficiency, the effect of a spreading of light in the scintillator layer is small compared to the case using amorphous silicon photodiodes. Thus the scintillator layer can be thinner and the x-ray dose can be lower. Thinner scintillator layers reduce crosstalk between neighboring pixels, increasing the contrast ratio. The GaAs on silicon wafer provides a suitable size to image, for example, for breast radiography and mammography with low x-ray doses and high resolution.

GaAs can be made, for example, on silicon wafers of up to 12″ or more in diameter, which enables a significant reduction in the cost for manufacturing GaAs semiconductors and opto-electronic systems. Two-dimensional arrays are formed from GaAs grown on large silicon wafers. Each cell of GaAs forms a special imaging unit to produce electrical signals from an x-ray photon. GaAs thin film transistors and photodiodes in the GaAs layer and additional transistors in the silicon wafer underneath the unit cell may be configured into logical circuits. The pixels and the logical circuits convert the x-ray image to digital signals. An active matrix of circuits may be configured as a two-dimensional array, with dimensions of up to the diameter of the substrate.

The flat panel of the GaAs detector is placed behind an object, for example, a human body. X-rays pass through the object and strike the surface of the flat panel. When x-rays strike the scintillator layer, the x-rays generate visible light, and the visible light is absorbed by the GaAs photodiodes in the array. The photodiodes convert the light signals to electric charges. Each pixel collects a signal proportion to the local flux of the x-ray beam. Then after each scan of the GaAs thin film transistor arrays, the stored electric charges are converted to digital signals for output from the conversion circuitry.

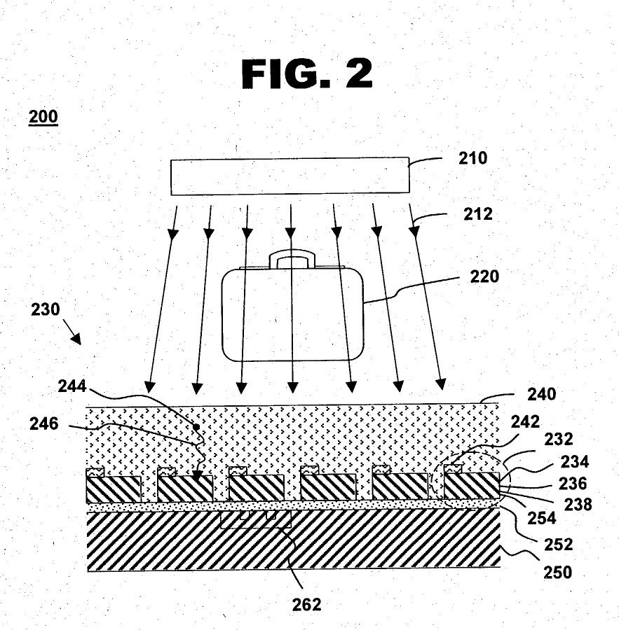

FIG. 2 shows a system for digital x-ray imaging, in accordance with one embodiment of the present invention at 200. Digital x-ray imaging system 200 includes an x-ray detector array 230.

X-ray detector array 230 includes a silicon substrate 250, a compound semiconductor layer 254 operably disposed on the silicon substrate, and a scintillator layer 240 operably disposed on compound semiconductor layer 254. Digital x-ray imaging system 200 may include an x-ray source 210 that emits x-rays 212. X-rays 212 from x-ray source 210 traverse a target object 220 and are detected by x-ray detector array 230 to provide an x-ray image corresponding to the x-rays traversing target object 220. X-rays 212 from x-ray source 210 are absorbed in scintillator layer 240. Scintillator layer 240 emits light in response to the absorbed x-rays. In the illustration, an x-ray 212 is absorbed at a point 244 within scintillator layer 240 to generate light 246.

The mechanism of converting incident x-rays to visible light in the scintillator layer can be described as three steps. The first step is photo-excitation in which the electrons of the scintillator atoms are excited to a high-energy state. The second step is ionization, in which excited electrons further ionize to pairs of electrons and holes. In the third step, the electrons and holes recombine and generate visible light. Emitted light 246 may be in the visible range, in the ultraviolet range, or in the infrared range. The scintillator material is selected to emit light that can be readily detected by a photodetector such as a photodiode in compound semiconductor layer 254. X-ray detector array 230 includes an array of imaging pixels 232 to detect light 246 from scintillator layer 240 and to provide an x-ray image corresponding to the x-rays traversing the target object.

Imaging pixels 232 include an array of imaging elements 234. Imaging element 234 may include a photodetector such as a photodiode, a phototransistor, a p-i-n diode, or any suitable device for converting light from scintillator layer 240 into a measurable electrical signal. Imaging element 234 may include, for example, a photodiode 236 and a field-effect transistor (FET) 238. FET 238 may be used to gate photodiode 236 for generating images. A metal layer 242 may cover FET 238 to block emitted light from scintillator layer 240 from striking the transistor. Metal layer 242 may comprise a patterned layer of gold, aluminum, titanium, tungsten, or other metal or metal alloy compatible with the processes for manufacturing x-ray detector array 230.

A buffer layer 252 may be positioned between compound semiconductor layer 254 and silicon substrate 250. Buffer layer 252 provides electrical insulation between compound semiconductor layer 254 and silicon substrate, and aids in the manufacture of thin layers of high quality, low-defect density compound semiconductor material on the silicon substrate. Buffer layer 252 provides strain relief between compound semiconductor layer 254 and silicon substrate 250, particularly during wafer processing where temperature cycles are higher than normal operating regimes.

Conversion circuitry 262 may be formed in silicon substrate 250 to provide a digital output corresponding to the x-ray image. Conversion circuitry may be formed in part in silicon substrate 250. Conversion circuitry 262 may be formed by a set of electronic devices such as transistors, resistors and capacitors to convert electrical signals from the imaging elements into an x-ray image. Conversion circuitry 262 may be formed in the silicon substrate prior to forming buffer layer 252 and compound semiconductor layer 254. The formation of the electronic devices can be formed in silicon substrate 250 and compound semiconductor layer 254 using semiconductor processes such as deposition, lithography, etch, oxidation, ion implantation, heat treatment and drive sequences as is known in the art.

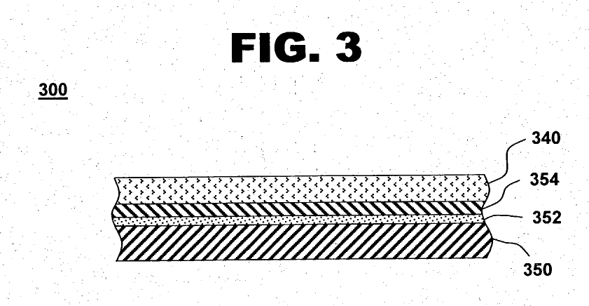

FIG. 3 shows a cross-sectional view of a portion of a digital x-ray imaging system, in accordance with one embodiment of the present invention at 300. Digital x-ray imaging system 300 includes a silicon substrate 350, a compound semiconductor layer 354, and a scintillator layer 340. Digital x-ray imaging system 300 may include a buffer layer 352 between silicon substrate 350 and compound semiconductor layer 354.

Silicon substrate 350 may comprise, for example, a silicon wafer standardly used in semiconductor processing, such as p-doped or n-doped single-crystal silicon wafer, with crystalline orientation such as (100), (111) or (110). Silicon substrate 350 may comprise a portion of a silicon wafer, having been processed at the wafer level and subsequently diced or sawed using sawing techniques known in the art. Current state-of the art silicon substrates are available in sizes up to 300 millimeter in diameter. Therefore, the x-ray imaging system may include an array of imaging elements as large as 300 millimeters for large-panel imaging systems. The array of imaging elements may have a length and a width up to 300 millimeters or larger, as larger wafer sizes and substrates become available.

Since x-rays are not readily focused, large panels with arrays of imaging pixels are desired for two-dimensional x-ray imaging of larger target objects. Large arrays of x-ray imaging pixels can be made on a single substrate without requiring tiling of smaller arrays. High-density cell arrays can provide high-resolution images.

For smaller target objects, smaller arrays of imaging elements may be desired. For example, the array of imaging elements for smaller target objects may have a length and a width of 10 millimeters or less.

Depending on the wafer processing technology, the size of wafer can be made as large as 12 inches in diameter. Thus the size of a square panel cut from the wafer can be 8.5 inches×8.5 inches. This will allow the size of each pixel unit to be 350 um×350 um for a 600×600 element array. For a pixel size of 100 um×100 um, a panel array with 2000×2000 pixels can be made for superior resolution for many medical, scientific and commercial applications. Pixel sizes or 10 um or below result in smaller panels with high resolution.

Buffer layer 352 comprises a relatively thin layer of material, positioned between silicon substrate 350 and compound semiconductor layer 354. Buffer layer 352 may comprise, for example, strontium titanate (STO). Buffer layer 352 may comprise a material such as barium strontium titanate (SrBaTiO), strontium zirconate (SrZrO), barium zirconate (BaZrO); or binary and ternary depositions of titanium arsenide (TiAs), titanium arsenic oxide (TiAsO), titanium gallium oxide (TiGaO), strontium arsenic oxide (SrAsO), strontium gallium oxide (SrGaO), or strontium aluminum oxide (SrAIO). Buffer layer 352 provides electrical isolation between silicon substrate 350 and compound semiconductor layer 354. Buffer layer 352 aids in the growth of compound semiconductor layer 354 on silicon substrate 350 by mitigating crystal lattice mismatches between silicon substrate 350 and compound semiconductor layer 354 so that high-quality, low defect compound semiconductor layers can be formed. Buffer layer 352 may have a thickness, for example, between 2 nanometers and 100 nanometers.

Compound semiconductor layer 354 may comprise a layer of gallium arsenide (GaAs). Compound semiconductor layer 354 may comprise a layer of another compound semiconductor material, for example, gallium indium arsenide (GaInAs), gallium aluminum arsenide (GaAlAs), aluminum indium gallium phosphide (AlInGaP), gallium phosphide (GaP), gallium arsenic phosphide (GaAsP), indium gallium nitride (InGaN), indium phosphide (InP), cadmium sulfide (CdS), cadmium mercury telluride (CdHgTe), or zinc telluride (ZnTe). Compound semiconductor layer 354 may have a thickness, for example, between 0.5 micrometers and 10 micrometers and thicker. In some applications, compound semiconductor layer 354 may be less than 0.5 micrometers thick.

Scintillator layer 340 may comprise a layer of cesium iodide (CsI), gadolinium oxysulfide (GdOS), zinc iodide (ZnI), cadmium iodide (CdI), a phosphor, or any suitable scintillator material for converting incident x-ray radiation into detectable light. Scintillator layer 340 may be formed or otherwise attached onto compound semiconductor layer 354. The thickness of scintillator layer 340 may be between, for example, 50 micrometers and 200 micrometers. A thinner layer of scintillator is preferable to minimize the spreading of visible light, achieving a higher contrast ratio.

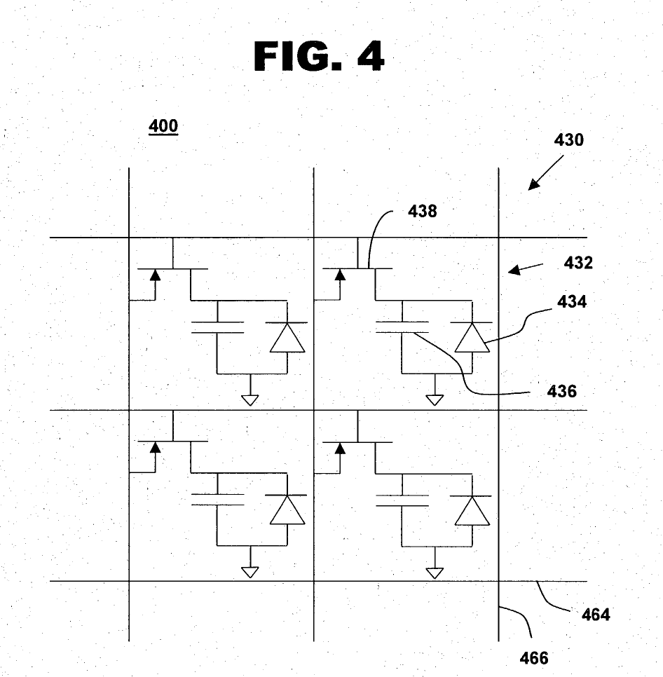

FIG. 4 shows a schematic illustration of a portion of a digital x-ray imaging system with a plurality of imaging pixels, in accordance with one embodiment of the present invention at 400. X-ray imaging system 400 includes an array of imaging pixels 430. Each imaging pixel 430 includes an imaging element 432.

Imaging element 432 may contain a photodiode 434, with an n-type region and a p-type region with a depletion region in between. When light from the scintillator layer is absorbed in the depletion region of photodiode 434, photodiode 434 generates electron-hole pairs that are separated and swept to the n-type regions and p-type regions. The swept charges may be temporarily stored in a diode capacitor 436 formed by the depletion region, the n-type region and the p-type region of photodiode 434. This charge may be amplified and read out, for example, with a readout circuit coupled to the array of imaging elements to provide an electrical output from a set of imaging elements 432.

Alternatively, imaging element 432 may contain a photodiode 434 and a field-effect transistor 438 to gate photodiode 434. Charge or current generated by photodiode 434 in response to absorbed light from the scintillator may be stored in diode capacitor 436. FET 438, when turned on, can dump the charge stored in diode capacitor 436 onto an output line connected to a readout circuit. A metal layer may be positioned on imaging pixel 430 to cover FET 438 and to block emitted light from the scintillator layer from striking the transistor. In order to prevent the effect of potentially damaging radiation on the transistor, the metal cover layer is deposited on top of the compound semiconductor layer, separated by a solid dielectric layer.

The readout process from the photodetector and FET circuit can be a controlled scanning row by row in a sequential manner. The parallel data along the column lines with the activated row may be multiplexed and converted to digital information.

The readout circuit may include, for example, a voltage amplifier, a transimpedance amplifier, a charge amplifier, or a current amplifier. The amplifier output provides a measure of the absorbed x-rays. The readout circuit may include one or more analog-to-digital converters to digitize the amplified output from one or more imaging pixels 430. The readout circuit may contain multiplexing circuits and timing circuits to prepare the data for further processing.

An addressable readout circuit may be coupled to the array of imaging elements, to provide an electrical output from a set of imaging elements in the imaging element array. For example, the addressable readout circuit may provide an electrical output from a row of imaging elements in the detector array. In other examples, the addressable readout circuit may provide an electrical output from a column of imaging elements, an individual imaging element, or a group of imaging elements. A row of output from the array of imaging outputs may be provided, for example, by selecting a row of imaging elements with an electrical signal applied to a scan or row select line 464. For example, a logical high voltage applied to all of the FETs in a row gates a charge from diode capacitor 436 onto a set of output or data lines 466. Each consecutive row may be scanned in a predetermined sequence. The rows may be scanned to obtain a complete frame of an x-ray image. Additional frames may be generated to provide a continuous x-ray image. With sufficient signal strengths and fast response from the imaging elements, real-time moving images or videos of the target object can be generated.

Conversion circuitry may be coupled to the readout circuit. The conversion circuitry may contain multiplexing circuits, formatting circuits, timing circuits and A/D converters to digitize the imaging element output and transform it into a suitable format for storing, sending, processing, or displaying.

The size and quantity of the imaging elements may be selected to provide a digital x-ray image with a desired resolution for displaying and for inspecting. For example, a digital x-ray detector array can have 600×800 pixel elements arranged in a rectangular array. With more pixel elements, higher imaging resolution can be obtained.

The size of individual pixel elements or the spacing between imaging elements can be large in cases where a large imaging area is desired and the monitor resolution is modest. The size of the imaging element may be made large, for example, when high sensitivity is desired or when low doses of x-rays are available. The imaging elements can have a length or a width between 100 micrometers and 1000 micrometers.

The size of the pixel elements or the spacing between imaging elements can be smaller in cases where high image resolution is desired, or the target object is small. The imaging elements can have a length or a width of 10 micrometers or smaller, and up to 100 micrometers or lager.

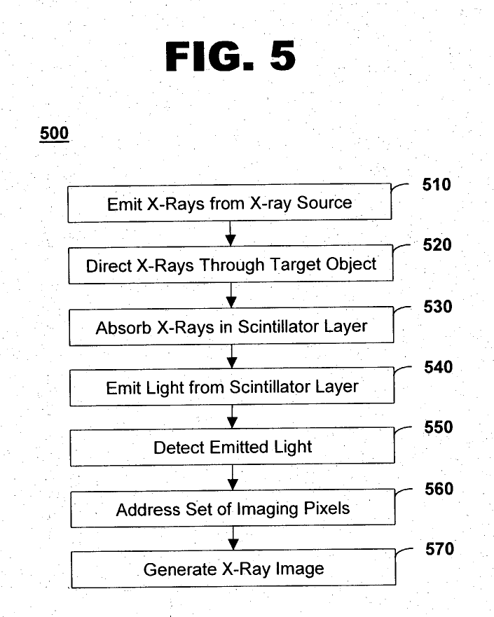

FIG. 5 shows a flow diagram of a method for generating an x-ray image, in accordance with one embodiment of the present invention at 500. X-ray imaging method 500 includes steps to generate a digital x-ray image.

X-rays are generated by an x-ray source, as seen at block 510. The x-rays are directed through a target object, as seen at block 520. X-rays that traverse the target object have an intensity distribution based on the absorption of x-rays within the target object, and can be used to generate an x-ray image from an x-ray detector array.

X-rays that pass through the target object are absorbed by a scintillator layer, as seen at block 530. The x-rays may also pass through the scintillator layer, though only a portion of the x-rays need to be absorbed in the scintillator layer.

Light is emitted from the scintillator layer in response to the absorbed x-rays, as seen at block 540. The light is emitted when an x-ray is absorbed in the scintillator material, and an electron is excited into a higher energy state and then collapses back into a lower energy level. Alternatively, an electron may be ejected and the scintillator material becomes ionized. The ejected electron may collapse back into a lower energy state to generate light, or cause another electron to be excited or ejected, which in turn may also generate light or excite other electrons.

Light emitted from the scintillator layer is detected with an array of imaging pixels, as seen at block 550. The array of imaging pixels includes a silicon substrate, a compound semiconductor layer on the silicon substrate, and a scintillator layer on the compound semiconductor layer. Each imaging pixel includes an imaging element such as a photodiode in the compound semiconductor layer to detect the emitted light from the scintillator layer. Alternatively, each imaging pixel may include a photodiode and a field-effect transistor to gate the photodiode. A metal layer may be positioned over the field-effect transistor to block emitted light from the scintillator layer from striking the field-effect transistor. The compound semiconductor layer may include gallium arsenide or one of a host of other compound semiconductor materials such as gallium indium arsenide, gallium aluminum arsenide, aluminum indium gallium phosphide, gallium phosphide, gallium arsenic phosphide, indium gallium nitride, indium phosphide, cadmium sulfide, cadmium mercury telluride, or zinc telluride. A buffer layer may be positioned between the silicon substrate and the compound semiconductor layer.

A set of imaging pixels may be addressed with an addressable readout circuit to detect the emitted light, as seen at block 560. The set of imaging elements may be, for example, a row of imaging elements, a column of imaging elements, an individual imaging element, or a group of imaging elements. The imaging pixels may be addressed and read out to produce, for example, an x-ray image or a moving x-ray video.

An x-ray image is generated based on the detected emitted light from the scintillator layer, as seen at block 570. Conversion circuitry in the silicon substrate or external to the x-ray detector array may be used to provide a digital x-ray image corresponding to x-rays striking the x-ray detector array. Conversion circuitry in the silicon substrate may be used to generate the x-ray image.

While the embodiments of the invention disclosed herein are presently preferred, various changes and modifications can be made without departing from the spirit and scope of the invention. The scope of the invention is indicated in the appended claims, and all changes that come within the meaning and range of equivalents are intended to be embraced therein.

What is claimed is:

1. A system for digital x-ray imaging, comprising:
a silicon substrate;
a compound semiconductor layer including an array of imaging elements, the compound semiconductor layer operably disposed on the silicon substrate; and
a scintillator layer operably disposed on the compound semiconductor layer, wherein x-rays emitted from an x-ray source traversing a target object are absorbed in the scintillator layer that emits light in response to the absorbed x-rays, the emitted light being detected by the array of imaging elements to provide an x-ray image corresponding to the x-rays traversing the target object.

2. The system of claim 1 wherein the compound semiconductor layer comprises gallium arsenide.

3. The system of claim 1 wherein the compound semiconductor layer comprises a semiconductor material selected from the group consisting of gallium indium arsenide, gallium aluminum arsenide, aluminum indium gallium phosphide, gallium phosphide, gallium arsenic phosphide, indium gallium nitride, indium phosphide, cadmium sulfide, cadmium mercury telluride, and zinc telluride.

4. The system of claim 1 wherein each imaging element comprises a photodiode.

5. The system of claim 1 wherein each imaging element comprises a photodiode and a field-effect transistor to gate the photodiode.

6. The system of claim 5 further comprising:
a metal layer covering the field-effect transistor to block emitted light from the scintillator layer from striking the field-effect transistor.

7. The system of claim 1 wherein each imaging element has a length or a width between 10 micrometers and 100 micrometers.

8. The system of claim 1 wherein each imaging element has a length or a width between 100 micrometers and 1000 micrometers.

9. The system of claim 1 wherein the array of imaging elements has a length or a width between 10 millimeters and 300 millimeters.

10. The system of claim 1 wherein the scintillator layer comprises a material selected from the group consisting of cesium iodide, gadolinium oxysulfide, zinc iodide, cadmium iodide, a phosphor, and a suitable scintillator material.

11. The system of claim 1 further comprising:
a buffer layer positioned between the compound semiconductor layer and the silicon substrate.

12. The system of claim 11 wherein the buffer layer comprises strontium titanate.

13. The system of claim 11 wherein the buffer layer comprises a material selected from the group consisting of barium strontium titanate, strontium zirconate, barium zirconate, titanium arsenide, titanium arsenic oxide, titanium gallium oxide, strontium arsenic oxide, strontium gallium oxide, and strontium aluminum oxide.

14. The system of claim 1 further comprising:
an addressable readout circuit coupled to the array of imaging elements, the addressable readout circuit providing an electrical output from a set of imaging elements in the imaging element array.

15. The system of claim 14 wherein the set of imaging elements is selected from the group consisting of a row of imaging elements, a column of imaging elements, an individual imaging element, and a group of imaging elements.

16. The system of claim 1 further comprising:
conversion circuitry in the silicon substrate to provide a digital output corresponding to the x-ray image.

17. A method of generating an x-ray image, comprising:
absorbing x-rays in a scintillator layer, the x-rays having passed through a target object;
emitting light from the scintillator layer based on the absorbed x-rays;
detecting the emitted light with an array of imaging pixels, the array of imaging pixels comprising a silicon substrate, a compound semiconductor layer operably disposed on the silicon substrate, and a scintillator layer operably disposed on the compound semiconductor layer; and
generating an x-ray image based on the detected emitted light.

18. The method of claim 17 wherein the compound semiconductor layer comprises gallium arsenide.

19. The method of claim 17 wherein each imaging pixel includes a photodiode in the compound semiconductor layer to detect the emitted light from the scintillator layer.

20. The method of claim 17 wherein each imaging pixel includes a photodiode to detect the emitted light from the scintillator layer, a field-effect transistor to gate the photodiode, and a metal layer covering the field-effect transistor to block emitted light from the scintillator layer from striking the field-effect transistor.

21. The method of claim 17 wherein the array of imaging pixels includes a buffer layer positioned between the silicon substrate and the compound semiconductor layer.

22. The method of claim 17 wherein the x-ray image is generated by conversion circuitry in the silicon substrate.

23. The method of claim 17 further comprising:
addressing a set of imaging pixels in the imaging pixel array with an addressable readout circuit to detect the emitted light.

24. A digital x-ray imaging system, comprising:
an x-ray source;
an x-ray detector array to detect x-rays from the x-ray source, the x-ray detector array comprising a silicon substrate, a compound semiconductor layer operably disposed on the silicon substrate, and a scintillator layer operably disposed on the compound semiconductor layer; and
a conversion circuit coupled to the x-ray detector array, the conversion circuit generating an x-ray image from the x-rays striking the x-ray detector array.

25. The digital x-ray imaging system of claim 24 further comprising:
a buffer layer positioned between the silicon substrate and the compound semiconductor layer.
